(19) United States
(12) Patent Application Publication
(10) Pub. No.: US 2026/0230037 A1
(43) Pub. Date: Aug. 6, 2026

(54) SOLAR TILE WITH FIRE EXTINGUISHING EQUIPMENT AND FIRE PROTECTION SYSTEM FOR A BUILDING

(71) Applicant: SolteQ GmbH, Oberlangen (DE)

(72) Inventor: Berkay BAYER, Oberlangen (DE)

(73) Assignee: SolteQ GmbH, Oberlangen (DE)

(21) Appl. No.: 19/293,650

(22) Filed: Aug. 7, 2025

(30) Foreign Application Priority Data
Feb. 6, 2025 (DE) 202025100606.5

(51) Int. Cl. H02S 40/42; A62C 3/02; A62C 35/68; H02S 20/25; H02S 20/26

(52) U.S. Cl. CPC H02S 40/425; A62C 3/0214; A62C 35/68; H02S 20/25; H02S 20/26

(57) ABSTRACT

A solar tile with fire extinguishing equipment function and a fire protection system for a building to improve fire protection for buildings with solar cells and to facilitate the installation. The solar tile is used in a corresponding systems. The simple arrangement of an edge profile, in particular a profile made of plastic or metal that often already exists, creates a quick, simple and robust method of distributing water over a large area. The solar tile has a water line. The water line has at least one inlet connection. The water line may also have one outlet connection between which it extends. The water line has at least one outlet, said outlet being designed to supply water from the water line to the or to an adjacent solar tile.

### TECHNICAL FIELD

The invention relates to a solar tile with fire protection function and a fire protection system for a building.

### BACKGROUND ART

CN 211456709 U describes the arrangement of water outlets between solar cells for extinguishing. US20190169841 A1 describes a building with fire protection panels and solar cells.

### SUMMARY OF THE INVENTION

The object of the invention is to improve fire protection for buildings with solar cells and to facilitate the installation.

The object is achieved with a solar tile and a corresponding system. The simple arrangement of an edge profile, in particular a profile made of plastic or metal that often already exists, creates a quick, simple and robust method of distributing water over a large area.

The object is achieved by a solar tile having a water line, said water line having at least one inlet connection and in particular also one outlet connection between which it extends in particular, and at least one outlet, said outlet being designed to supply water from the water line to the or to an adjacent solar tile

The object is also achieved by a system comprising a plurality of, in particular identical, solar tiles according to one of the preceding claims, said solar cells being arranged in at least one direction, in particular in two directions, next to one another and in particular overlapping in one of the directions, with the water lines of the solar tiles arranged next to one another in one of the directions being joined to form a continuous water line created in particular purely by the solar tiles.

The object is also achieved by a system comprising a plurality of, in particular identical, solar tiles according to one of the preceding claims and at least one water tank, at least one riser and at least one pump, designed to pump water by means of the pump from the water tank through the riser into a line system formed by the water lines of the plurality of solar tiles.

A building having a system according to the invention in which the solar tiles form at least part of the roof and/or the façade, in particular the complete roof and/or façade, and in particular in which the building has a fireproof layer under the solar tiles, also achieves the object.

Particularly advantageously the water line extends across the solar tile, in particular along one edge of the solar tile, the front glass pane of the solar tile and/or the solar active surface of the solar tile. This makes for a particularly easy installation and allows a wide water discharge, for example through holes spread over the width.

For this, inlet and/or outlet connections are arranged in particular on opposite sides of the solar tiles, in particular arranged and designed in such a way that the water line of two identical solar tiles is pushed together and connected by arranging the solar tiles next to each other, in particular by connecting the inlet connection of one solar tile to the outlet connection of the other solar tile, in particular by pushing them into each other. However, other embodiments are also conceivable, for example with inlet and/or outlet connections consisting of short lengths of hose that can be connected to each other, in particular behind the solar tiles.

Advantageously, the at least one outlet is arranged and designed to supply water to the solar active surface of the or of an adjacent solar tile, in particular overlapped by the solar tiles and/or arranged below them, and/or is an integral part of the water line. The outlet can thereby be formed, for example, by holes in or nozzles moulded onto the water line. This enables a particularly simple and reliable implementation as well as reliable wetting of the solar active surface and in particular of the entire roof cladding.

In one particular embodiment, the system includes at least one temperature sensor or temperature fuse arranged below or under the plurality of solar tiles and/or below or under the at least one solar active elements of the at least one solar cell.

In one particular embodiment, the solar tile has at least one secondary outlet designed to discharge water from the or from a second water line under the solar tile, for example onto an underlay. In an alternative embodiment, only one such outlet can be provided below the solar tile. This can create a further barrier. This outlet can also be used to cool the building.

Under a solar tile is to be seen in particular in the direction from the transparent cover layer towards the solar active substance behind the solar tile. A further solar tile arranged under a first solar tile is advantageously also arranged below in this sense, since it overlaps, but in particular is also arranged below at least in the direction of an inclination of the building envelope (in particular the façade or roof).

Advantageously, the water line and in particular also the inlet and/or outlet connection and in particular also the at least one outlet forms part of an edge profile, in particular a one-piece edge profile, of the solar tile, said edge profile being bonded in particular to the solar cell of the solar tile. This enables particularly simple production and installation of the solar tiles. In particular, this can be an edge profile located on the upper or lower edge. In the case of an edge profile located on the upper edge, the outlets are designed in particular to direct water onto the solar active surface of the solar tiles. In this case, the water line is arranged in particular above the solar active layer and/or upper layer. In the case of an edge profile located on the lower edge, the outlets are designed in particular to direct water onto a solar tile located below the solar tiles in an arrangement of a plurality of (identical) solar tiles. In this case, the water line is arranged in particular below the solar active layer.

The edge profile is in particular extruded. This simplifies production. In addition, further steps can preferably be carried out during production, such as the insertion of an inlet connection and/or the creation of at least one outlet.

The edge profile can also be designed to secure the solar tiles, for example with a protruding stop and/or contact surface for contact with a roof batten.

Advantageously the solar tile can, in particular at the end opposite the edge profile and/or the stop and/or the contact surface and/or on the same side as the stop and/or the contact surface, have a hook, in particular a flexible and/or spring-loaded hook, for fixing to and/or engaging behind a roof batten and/or on an edge profile of a solar tile, in particular an identical solar tile, located below the solar tile This allows the solar tiles to be installed quickly, easily and reliably on roof battens.

Advantageously, the inlet and/or outlet connection has a seal ring. This can simplify the leak-tight installation.

The solar tile is advantageously designed to make it more difficult for water to be pushed over the solar active surface via an edge of the solar tile, in particular by means of an edge profile or the edge profile. This can be achieved by forming a deflector standing steeply up from the solar active surface, in particular at an angle of 60 to 120°, in particular with an overhang. The deflector is formed in particular over the entire width of the solar tile, with the overhang being formed in particular over at least 50% of the width. As a result, water ingress behind the solar tile(s) can be reduced, even if there is wind on the solar tiles.

The water line preferably extends in an edge profile, in particular a one-piece edge profile, of the solar tile and/or is inserted into and/or clamped in this profile, with this edge profile being in particular bonded to the solar cell of the solar tile.

The at least one outlet, and in particular the water line, is advantageously arranged in the upper area of the solar tiles and/or above the solar active surface, in particular also in the case of inclined solar tiles with an angle of inclination of the solar active surface to the horizontal in the range of 20 to 90° and/or in the installed state. This allows reliable wetting of all the solar tiles in a system to be achieved, and gravity can be advantageously used for wetting.

In one preferred embodiment, the at least one outlet is formed by one or more holes, for example produced by drilling, punching and/or melting, and/or by nozzle(s). This allows a simple and reliable design to be achieved.

Advantageously, the at least one outlet is designed to supply water to the solar tiles across the entire width of the solar tiles. It is not necessarily important that water is supplied over the entire length/height of the solar tiles across the entire width, but that at least the entire width is wetted somewhere on the solar tile. This is generally more the case in the lower half. This is because apart from the tiles in the top row of a tiled surface, the solar tiles are also preferably supplied with water from the solar tiles above.

The inlet connection is advantageously designed so that it can be connected to a connection identical to the outlet connection in a watertight manner and/or by plugging, in particular it protrudes laterally from the solar tile.

The solar tile preferably has a ventilation grille, in particular on an edge and/or side facing away from the water line, which extends in particular along one edge of the solar tile, the front glass pane of the solar tile and/or the solar active surface of the solar tile. This allows the space behind the solar tiles to be protected, for example from insects.

The system preferably comprises a plurality of, in particular identical, solar tiles such that the solar cells are arranged in at least one direction, in particular in two directions, next to one another and in particular overlapping in one of the directions, with the water lines of the solar tiles arranged next to one another in one of the directions being joined to form a continuous water line created in particular purely by the solar tiles. This makes it particularly easy to create an installation over a large area.

Advantageously, at least one temperature sensor, in particular at intervals of no more than 1 m, is located below each of the solar tiles and/or below the solar active elements of the solar cells. This allows heat development to be recognised particularly well and also smoldering fires to be stopped at an early stage. In particular, the system is designed to stop the pumping of water through the outlets and/or to disconnect the electrical connection lines of the solar tiles if a predetermined temperature is exceeded, in particular a temperature in the range from 90 to 150° C. The at least one temperature sensor can advantageously be designed as a fusible link.

The system preferably comprises at least one water tank, for example next to and/or under the building on which the solar tiles are arranged, and at least one riser and at least one pump designed to pump water by means of the pump from the water tank through the riser into a line system formed by the water lines of the plurality of solar tiles. In this way, wetting can be ensured even independently of a central water supply.

Advantageously, the solar tiles form at least part of the roof and/or the façade of a/of the building, in particular the complete roof and/or façade. As a further advantage, the building has a fire-resistant layer under the solar tiles, for example fire-resistant underlay and/or fibre cement panels This can further increase fire safety in the building. Advantageously, the system can also be designed to wet these from the outside, in particular by means of the water lines of the solar tiles, which are then designed in particular to supply water to the solar tiles and under the solar tiles.

Particularly advantageously, the building has vertical walls and an inclined roof, with the roof adjoining the vertical walls without forming a roof overhang. This further reduces the risk of a fire spreading to the building. It also avoids the significantly more difficult task of wetting the roof overhang—that is usually particularly susceptible to fire—from below.

In one embodiment, a system includes a plurality of solar cells or solar tiles having solar cells. The solar cells or solar tiles being arranged in at least one direction or at least two perpendicular directions including a multitude of temperature sensors or temperature fuses arranged below or under the solar cells or solar tiles.

Particularly advantageously, the multitude of temperatures sensors or temperature fuses is connected in series by at least one cable or wherein the multitude of temperatures sensors or temperature fuses are arranged each with a distance in between or in the range of about 25 cm to about 2 cm.

In one specific embodiment, the distance may be in the range of about 20 cm to about 2 cm. In a preferred embodiment, the distance may be in the range of about 15 cm to about 5 cm. In another specific embodiment, the distance may be in the range of about 12 cm to about 7 cm. In another specific embodiment, the distance may be in the range of about 10 cm to about 5 cm.

The system is or the temperature sensors or temperature fuses are arranged to detect an overtemperature in between or in the range of about 60° C. to 500° C.

In one specific embodiment, the overtemperature is in the range of 70° C. to 400° C. In a preferred embodiment, the overtemperature is in the range of 80° C. to 300° C. In another specific embodiment, the overtemperature is in the range of 80° C. to 250° C. In another specific embodiment, the overtemperature is in the range of 90° C. to 170° C.

### BRIEF DESCRIPTION OF THE DRAWINGS

Further advantageous embodiments and advantages are described purely by way of example with reference to the following schematic figures.

FIG. 1 is partial view of a solar tile.

FIG. 2 is a detailed view of the solar tile as shown in FIG. 1

FIG. 3 is an operational view of two solar tiles side by side with one another.

FIG. 4 is an operational view of two solar tiles pushed together to create an arrangement

Similar numbers refer to similar parts throughout the drawings.

### DETAILED DESCRIPTION

FIG. 1 shows a partial view of a solar tile 1 with a solar active surface 2 and an edge profile 5 with a water line integrated into the edge profile 5. The water line has an inlet connection 3 and an outlet connection at the opposite end. The inlet connection is fitted with a seal ring 4. The figure also shows that the solar tile also has a small lateral profile 6.

The edge profile 5 is arranged along the end of the upper edge of the solar tile and makes it more difficult for water to be pushed off the solar active surface over this edge. The edge profile is bonded to the solar active surface.

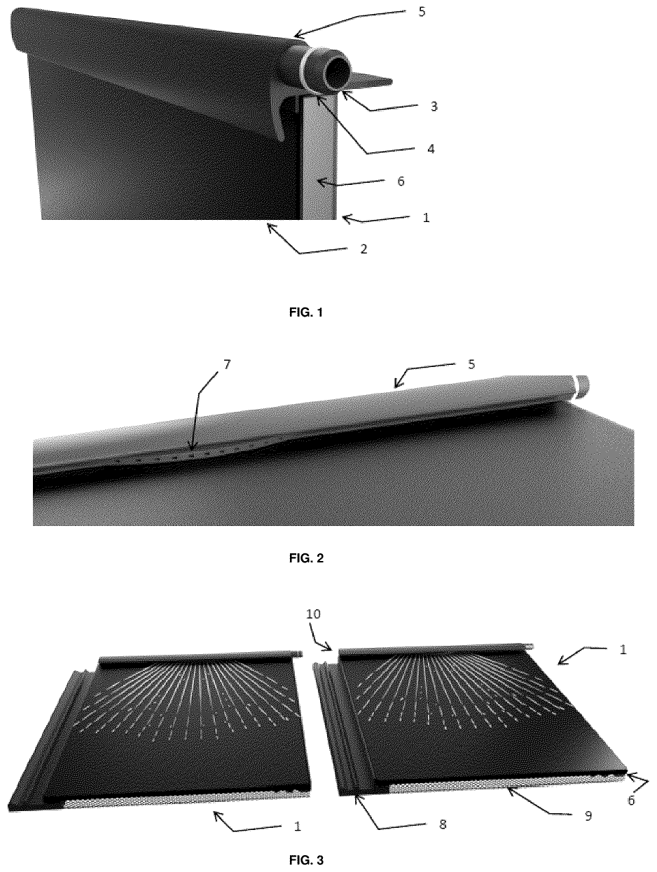

FIG. 2 shows a further detailed view of the solar tiles from FIG. 1 and shows the outlets 7 integrated into the profile. They are arranged such that they allow the supplied water to escape at different speeds in different directions in order to ensure the best possible distribution across the solar tiles.

FIG. 3 shows two solar tiles 1 side by side as shown in the figures above. A large lateral profile 8 and a grille 9 can also be seen in each case. The location of the outlet connection 10 is also marked.

The water supplied via the outlets is also indicated by dotted lines.

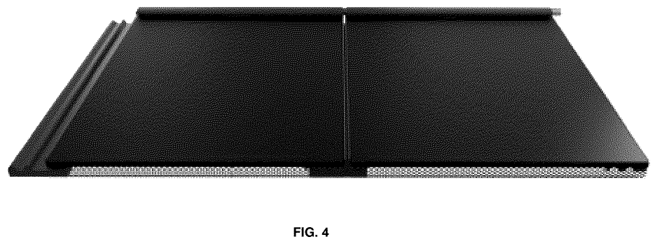

The solar tiles can simply be pushed together to create an arrangement as shown in FIG. 4. Here the inlet connection of the left solar tile is pushed into the outlet connection of the right solar tile to create a continuous water line. The large lateral profile engages behind the small lateral profile. In this way, a row of any length can be created, but which can also be terminated with different types of tile (at each end).

As usual with roof tiles, such rows can be arranged so that they partially overlap above one another. Here the profile can be arranged behind the grille of the row above so that it is protected. The water from the row above can then continue to flow over the row(s) below. The profiles also make it more difficult for the water to be pushed under the tiles by the wind.

The water lines of the individual rows can be connected in series or parallel/star-shaped by means of suitable connections. End openings in the water line are closed, particularly in the case of parallel/star-shaped connections, in particular by plugs.

| | Legend |
|---|---|
| 1 | Solar cell |
| 2 | Solar-active layer |
| 3 | Seal |
| 4 | Inlet connection |
| 5 | Profile |
| 6 | Small lateral profile |
| 7 | Outlet |
| 8 | Large lateral profile |
| 9 | Grille |
| 10 | Outlet connection |

What is claimed is:

1. A solar tile having a water line, the water line having at least one inlet connection and at least one outlet, the outlet being designed to supply water from the water line to the solar tile or to an adjacent solar tile.

2. The solar tile according to claim 1, wherein the water line extends across the solar tile.

3. The solar tile according to claim 1, wherein the at least one outlet is arranged and designed to supply water to a solar active surface of the solar tile or of the adjacent solar tile or is an integral part of the water line.

4. The solar tile according to claim 1, wherein the water line and the inlet connection or the outlet forms part of an edge profile of the solar tile, or is inserted into or clamped on this edge profile or in which the water line extends in an edge profile, of the solar tile, or is inserted into or clamped on this profile.

5. The solar tile according to claim 1, wherein the solar tile or an edge profile of the solar tile is arranged on an edge of the solar tile is designed to hinder water to be pushed over the solar active surface via an edge or an edge profile of the solar tile.

6. The solar tile according to claim 1, wherein the at least one outlet is arranged in the upper area of the solar tiles or above a solar active surface.

7. The solar tile according to claim 1, wherein the at least one outlet is formed by one or more holes or wherein the at least one outlet is designed to supply water over the entire width of the solar tile onto the solar tile or the adjacent solar tile or a neighbouring solar tile.

8. The solar tile according to claim 1, wherein the inlet connection is designed so that it can be connected to a connection identical to an outlet connection in a watertight manner or by plugging.

9. The solar tile according to claim 1, wherein the solar tile has a ventilation grille which extends along one edge of the solar tile, at least one edge of a front glass pane of the solar tile or at least one edge of the solar active surface of the solar tile.

10. A system comprising a plurality of solar tiles according to claim 1, said solar cells being arranged in at least one direction or at least two perpendicular directions-next to one another, wherein the water lines of the plurality of solar tiles are arranged next to one another in one of the directions being joined to form a continuous water line.

11. The system according to claim 10, wherein the solar tiles are designed to hinder water to be driven behind the plurality of solar tiles or prevent water from being driven behind the plurality of solar tiles.

12. The system according to claim 10, wherein the solar tiles are designed such that water from a solar tile of the plurality of solar tiles can run down onto at least one solar tile of the plurality of solar tiles arranged below the solar tile.

13. The system according to claim 10 comprising at least one temperature sensor or temperature fuse arranged under the plurality of solar tiles or under at least one solar active elements of the at least one solar cell.

14. A system comprising a plurality of solar tiles according to claim 1 and at least one water tank, at least one riser, and at least one pump, wherein the system is designed to pump water via the at least one pump from the at least one water tank through the at least one riser into a line system formed by each water line of the plurality of solar tiles.

15. A building having a system according to claim 10, wherein the solar tiles form at least part of the roof or a façade or with the building having vertical walls and a sloping roof, wherein the roof adjoins the vertical walls without forming a roof overhang.

16. The system according to claim 10, wherein the water line is created purely by the solar tiles.

17. The solar tile according to claim 1, comprising having at least one outlet connection, said outlet connection being designed to supply water from the water line to an adjacent solar tile or wherein the water line extends along one edge of the solar tile, along one edge of a front glass pane of the solar tile or along one edge of a solar active surface of the solar tile or wherein the at least one outlet connection and the water line, are arranged in an upper area of the solar tiles or above a solar active surface.

18. The system according to claim 10, wherein the at least one outlet of at least one solar tile of the plurality of solar tiles is designed to supply water over an entire width of a neighbouring solar tile.

19. A system comprising a plurality of solar cells or solar tiles having solar cells said solar cells or solar tiles being arranged in at least one direction or at least two perpendicular directions comprising a multitude of temperature sensors or temperature fuses arranged under the plurality of solar cells or solar tiles.

20. The system of claim 19 wherein the multitude of temperature sensors or temperature fuses is connected in series by at least one cable or wherein the multitude of temperature sensors or temperature fuses are arranged each with a distance in between 15 cm and 5 m or wherein the system is or the temperature sensors or temperature fuses are arranged to detect an overtemperature in between 80° C. and 300° C. under the plurality of solar cells or solar tiles or wherein the system is arranged to trigger an alarm, to trigger dispensing of fire-fighting water or to cut the current through the solar tiles or solar cells in case of an overtemperature under the plurality of solar cells or solar tiles detected by the temperature sensors or temperature fuses are.
